(19) United States
(12) Patent Application Publication
(10) Pub. No.: US 2026/0196404 A1
(43) Pub. Date: Jul. 9, 2026

(54) ELECTRONIC COMPONENT, IN PARTICULAR A THREE-PHASE TRANSFORMER FOR AN ISOLATED VOLTAGE CONVERTER

(71) Applicant: VALEO ELECTRIFICATION, Cergy Pontoise (FR)

(72) Inventors: Amaury ROUET, Cergy Pontoise (FR); Wendell DA-CUNHA-ALVES, Cergy Pontoise (FR); Roger DENIOT, Cergy Pontoise (FR); Massourang DIALLO, Cergy Pontoise (FR); Baptiste PARIGOT, Cergy Pontoise (FR); Julien LEVEQUE, Cergy Pontoise (FR)

(73) Assignee: VALEO ELECTRIFICATION, Cergy Pontoise (FR)

(21) Appl. No.: 19/133,084

(22) PCT Filed: Nov. 28, 2023
(86) PCT No.: PCT/EP2023/083430

§ 371 Date: May 27, 2025

(30) Foreign Application Priority Data
Dec. 8, 2022 (FR) FR2212969

(51) Int. Cl. H01F 27/30; H01F 27/24

(52) U.S. Cl. CPC H01F 27/303; H01F 27/24

(57) ABSTRACT

An electronic component comprising a magnetic circuit, two electrical conductors each having a portion arranged around a single part of the magnetic circuit, each of the portions forming a winding between a first and a second end, these two windings being inductively coupled to each other via the magnetic circuit. A support for the two electrical windings is arranged between the electrical conductors and the part of the magnetic circuit. The support incorporates a guiding system for guiding at least one of the two electrical conductors outside the electrical winding that it defines.

The present invention relates to an electronic component comprising a magnetic circuit, and at least two electrical conductors each having a portion arranged around one and the same part of the magnetic circuit, each of said portions forming a winding between a first and a second end, these two windings being inductively coupled to one another via the magnetic circuit.

Such an electronic component defines, for example, a three-phase transformer for an isolated voltage converter, such a voltage converter being, for example, integrated into a component for supplying electric power to a vehicle electrical energy storage unit, also referred to as a “charger” for this electrical energy storage unit. The electrical energy storage unit is, for example, a battery, which can have a nominal voltage greater than 60 V, for example greater than or equal to 300 V, 400 V, 800 V, or even 1000 V. The voltage converter receives, for example, an AC voltage from an electrical network and provides the battery with a DC voltage. This converter can convey a power greater than 5 KW, for example greater than 7 kW, for example greater than 11 kW, in particular 22 kW or more.

The component receives electrical conductors which, for their portion not forming an electrical winding, are intended to be connected to the rest of the electrical circuit of the component. For reasons of safety, sound operation and space requirements, it is necessary that the portions of the electrical conductors outside the windings occupy a precise and defined position in the environment of these windings, and therefore that a guidance of these portions of at least one of the electrical conductors is proposed.

There is a need to provide this guidance in a simple and inexpensive way.

The object of the invention is to address this need, and this is achieved, according to one of its aspects, using an electronic component, comprising:
a magnetic circuit,
two electrical conductors each having a portion arranged around a same part of the magnetic circuit, each of said portions forming a winding between a first and a second end, these two windings being inductively coupled to one another via the magnetic circuit, and
a support of the two electrical windings, arranged between said electrical conductors and said part of the magnetic circuit,
   characterized in that the support integrates a guidance system of at least one of the two electrical conductors outside the electrical winding that it defines.

According to the invention, the guidance of at least one of the two electrical conductors outside the winding that it defines is integrated into the winding support. This avoids the need to use a separate and specific element to carry out this guidance.

The guidance system can guide at least one of the two electrical conductors outside the electrical winding that it defines beyond the first end of the electrical winding and beyond the second end of the electrical winding. Thus, for a given electrical conductor, the guidance is carried out outside the electrical winding, on each side of the electrical winding. The guidance system is, for example, arranged such that the guidance of the electrical conductor beyond the two ends of the electrical winding that it defines is carried out on the same side of the electrical winding support.

When the guidance system guides each of the two electrical conductors outside the electrical winding that it defines beyond the two ends of that winding, all of these portions beyond the ends can be arranged on the same side of the electrical winding support. In other words, the connection to the electrical windings is made from the same side of the electrical winding support.

The electrical conductors to the transformer primary can be connected in a star shape, as can the electrical conductors to the transformer secondary. In this case, each first end of a winding can lead to the outside of the transformer, and each second end can lead to a common point of the star-shaped assembly.

The support of the two electrical windings can comprise:
a wall around which the electrical windings are arranged, this wall defining, in particular, a hollow cylinder having a circular cross section, and
three edges offset along the longitudinal axis of the support so that one of the electrical windings is arranged between the first and the second edge and that the other of the electrical windings is arranged between the second and the third edge.

The gap between two consecutive edges can be constant or varied.

The guidance system can comprise a first clamp interworking with one of the electrical conductors beyond the first end of the electrical winding that it defines. Such a clamp defines in a broad sense a means of positioning this end of the electrical winding. The clamp has, for example, two arms curved such that they follow an area of the outline of this end of the electrical conductor. The electrical conductor has, for example, a circular outline. The two clamp arms can have an identical or different shape and/or dimensions. For example, the clamp is or is not made of a single piece with the rest of the guidance system.

The guidance system comprises, for example, a second clamp interworking with the electrical conductor beyond the second end of the electrical winding that it defines, these first and second clamps following one another along one of the first, second and third edges. For example, the first clamp has the same shape and/or dimensions as the second clamp. Thus, on the outside of each end of the same electrical winding, a positioning can be ensured by two clamps carried by the same edge.

The guidance system can comprise:
a first clamp interworking with one of the electrical conductors beyond the first end of the electrical winding that it defines, and a second clamp interworking with the electrical conductor beyond the second end of this electrical winding, these first and second clamps following one another along one of the first, second and third edges, and
a first clamp interworking with the other of the electrical conductors beyond the first end of the electrical winding that it defines and a second clamp interworking with this other electrical conductor beyond the second end of this electrical winding, these first and second clamps following one another along that edge amongst the first, second and third edges.

The same edge can thus carry clamps involved in positioning the two electrical conductors beyond each end of this winding.

The two first clamps can be separated by a distance greater than the shortest distance between a first clamp and a second clamp. Thus, on the same edge, a first clamp and a second clamp can be combined, and another first clamp and another second clamp can be combined.

The first edge can carry two first clamps and two second clamps, each interworking with an electrical conductor, and the second edge can carry a first clamp and a second clamp interworking with one of the electrical conductors, each clamp on the second edge being, in particular, aligned with a clamp on the first edge along the axis of the support. The provision of two clamps on the second edge allows the guidance of the electrical conductor of which the portion defining the electrical winding is arranged between the second edge and the third edge. The presence of clamps associated with this electrical conductor on the first edge allows further improvement of this guidance.

The guidance system can comprise two additional walls extending along the longitudinal axis of the support beyond the first edge, these two additional walls being offset and defining between them a guidance channel receiving the at least one of the electrical conductors outside the winding that it defines. If applicable, both electrical conductors can be received in this guidance channel. For example, the two electrical conductors are stacked in this channel. The two additional walls can define a constant gap between them, so that the channel maintains a constant dimension along the conductors.

This allows the guidance system to interact with the electrical conductor(s) via the above-mentioned clamp(s) and this guidance channel.

The wall around which the electrical windings are arranged defines, for example, a hollow cylinder having a circular cross section, and each additional wall defines a portion of cylinder beyond that wall defining the hollow cylinder. For example, one of these cylinder portions has the same radius as the wall defining the hollow cylinder.

Within the meaning of the present application:
“axially” means “along the axis of the wall around which the electrical windings are arranged”,
“angularly” means “while moving around this axis”, and
“radially” means “in a plane perpendicular to this axis, along a straight line cutting through this axis when this wall defines a hollow cylinder having a circular cross section”.

One of the additional walls can comprise openings for the passage of an electrical conductor to the electrical winding that it defines. This additional wall is, for example, the radially outermost wall of these two additional walls.

Each of these openings can be disposed radially in relation to a clamp.

Where appropriate, other openings can be provided in this additional wall for the passage of electrical conductors, these openings not being disposed radially in relation to a clamp.

Where applicable, the additional wall in which one or more openings are provided can be the radially innermost wall of the two additional walls.

Where applicable, each of the two additional walls comprises one or more openings, regardless of whether they are used to pass an electrical conductor to an electrical winding.

Each electrical conductor is, for example, made of Litz wire.

In all of the above, the support and the guidance system can be made of a single piece, for example made of a plastic such as polybutylene terephthalate (PBT), or polyamide (PA).

In all of the above, the electronic component can define a transformer for an isolated voltage converter.

The transformer is, for example, a three-phase transformer for an isolated voltage converter, comprising three supports of electrical conductors, each support being arranged around a part of the magnetic circuit and carrying two windings inductively coupled to one another via the magnetic circuit, the supports defining, in particular, a geometric pattern of an equilateral triangle.

Each support thus carries two windings which are inductively coupled to one another and which together define one phase of the three-phase transformer.

The arrangement of the three supports of electrical conductors in the form of an equilateral triangle can make it possible to guarantee that electrical parameters such as the inductances of the electrical windings are balanced and to reduce the magnetic volume.

The magnetic circuit can be made up of two parts, each part defining a base which carries pins, superposed two by two when these two parts are assembled, and the superposition of two studs defines the part of the magnetic circuit on which a support of two electrical conductors is mounted.

A further subject-matter of the invention, according to another of its aspects, is a component for supplying electric power to a vehicle electrical energy storage unit, comprising the transformer defined above. The electrical energy storage unit is, for example, a battery which can have one of the above nominal voltages.

The invention will be better understood upon reading the following description of non-limiting embodiments thereof:

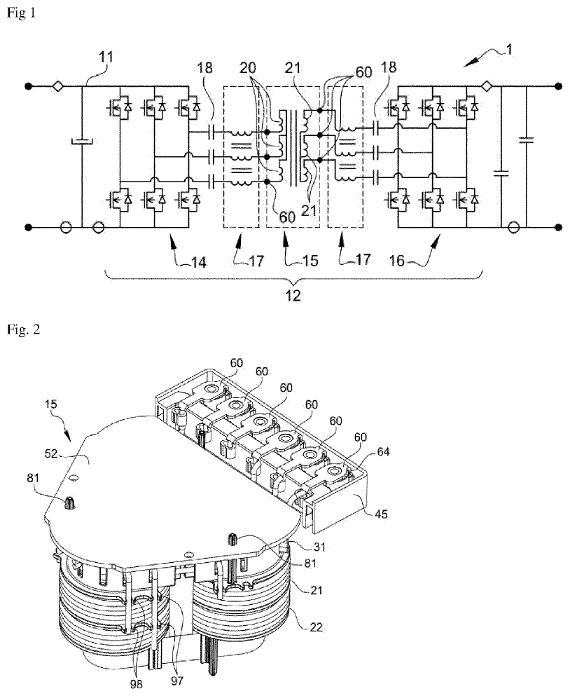

FIG. 1 schematically shows a part of the electrical circuit of a component for supplying electric power to a vehicle electrical energy storage unit,

FIG. 2 shows in elevation an example of a three-phase transformer which is able to be used in the circuit of FIG. 1,

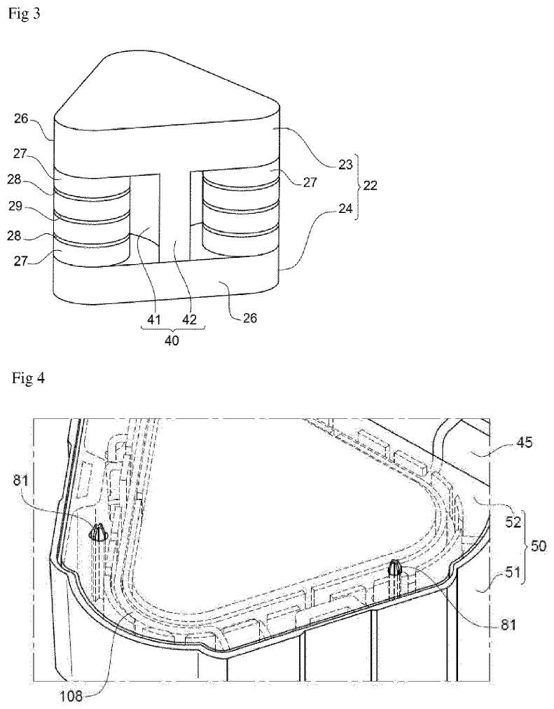

FIG. 3 shows in isolated fashion the magnetic circuit of the three-phase transformer of FIG. 2,

FIG. 4 partially shows the three-phase transformer from FIGS. 2 and 3 when the cover of the casing is removed,

FIG. 5 shows a detail of an example of a system for holding the cover of the casing of the transformer on the support,

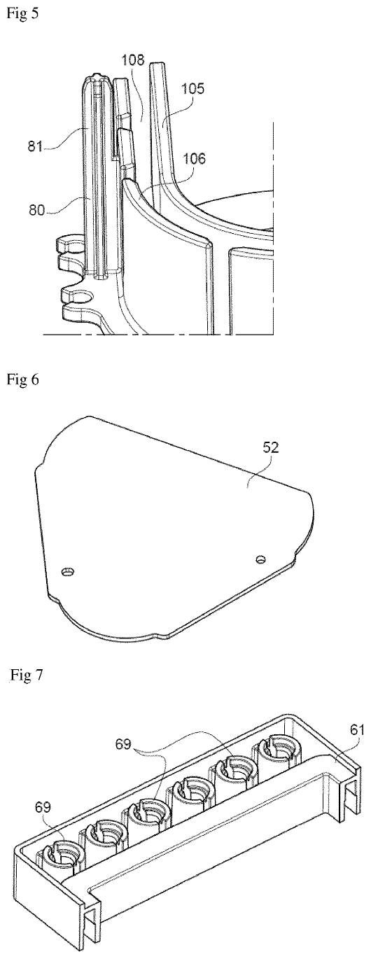

FIG. 6 shows the cover of the casing from FIG. 4,

FIG. 7 shows in isolation the body of the terminal block visible in FIG. 2,

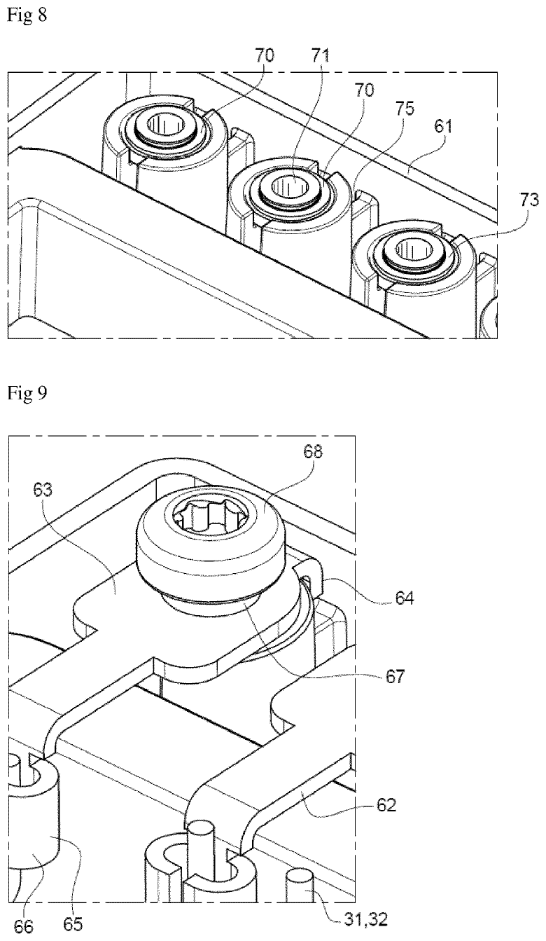

FIG. 8 shows the body of FIG. 7 in which inserts are arranged,

FIG. 9 shows the terminal block of FIGS. 7 and 8 with an electrically conductive bar and screw,

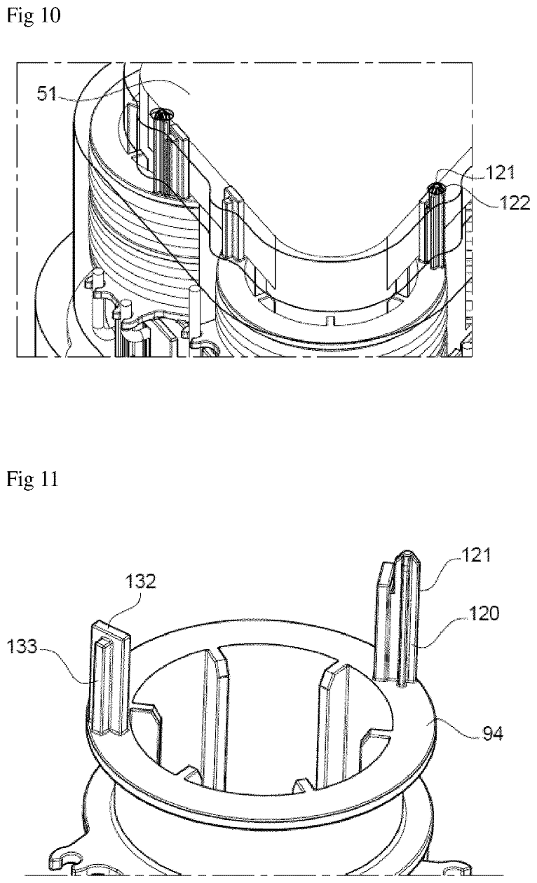

FIG. 10 shows that face of the transformer which is opposite that shown in FIG. 4,

FIG. 11 is a view of the support of electrical conductors of the transformer from the same side as FIG. 10, and shows the system for holding the support on the magnetic circuit and the system for holding the support on the body of the casing of the transformer which are carried by this support,

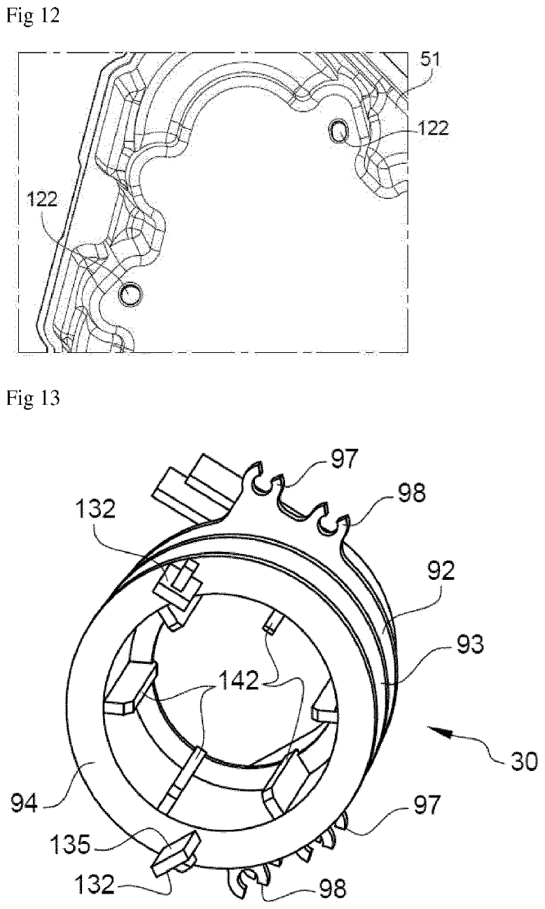

FIG. 12 shows the body of the casing of the transformer on which the support of electrical conductors of FIG. 11 is kept,

FIG. 13 is a view similar to FIG. 11 and also shows ribs which make it possible for this support to extend away from the portion of the magnetic circuit on which it is mounted,

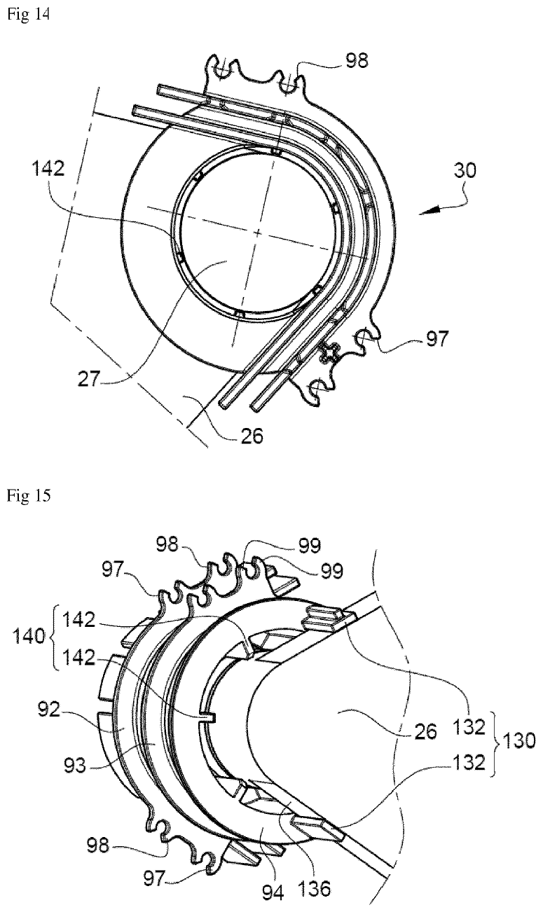

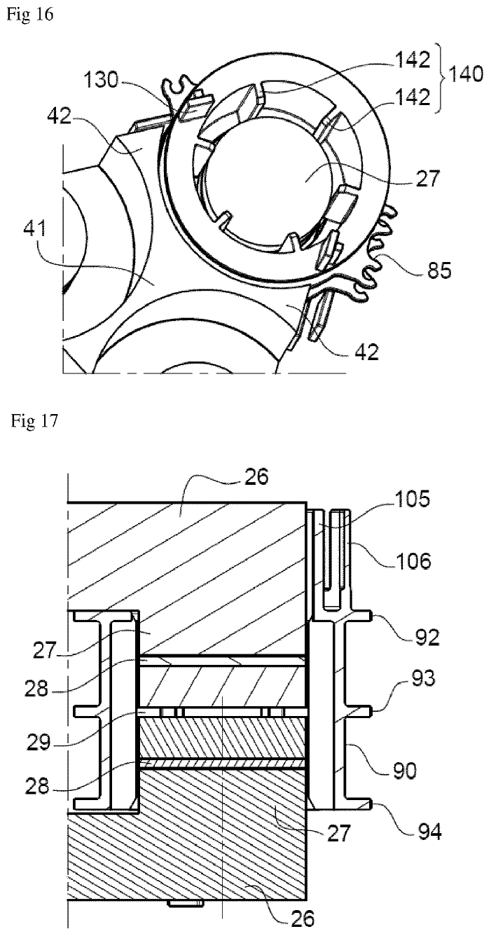

FIG. 14, FIG. 15 and FIG. 16 are views similar to that of FIG. 13 when the support of electrical conductors is mounted on the portion of the magnetic circuit,

FIG. 17 is a cross-sectional view of FIG. 16,

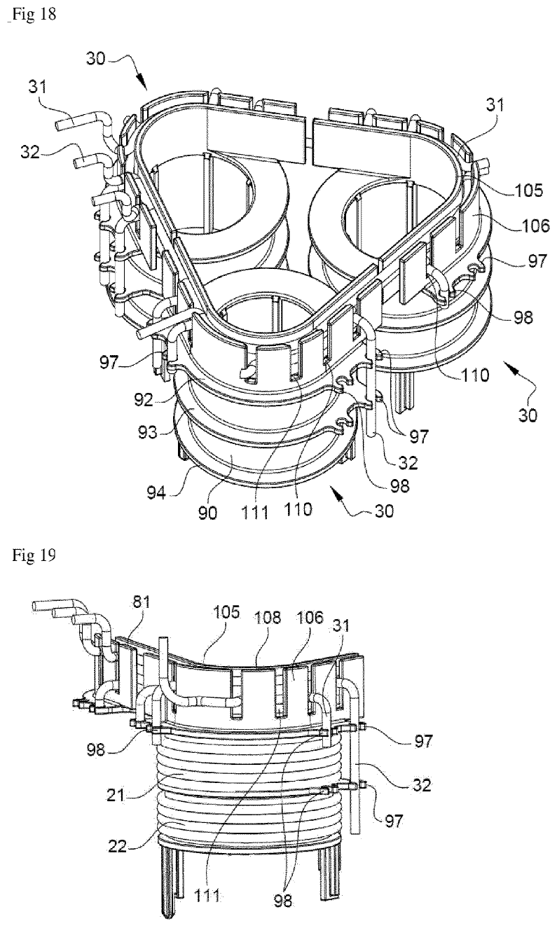

FIG. 18 shows three supports of the electrical conductors of the transformer and their electrical conductors, in the absence of the magnetic circuit,

FIG. 19 shows in isolated fashion one of the three supports of the electrical conductors from FIG. 18 with its electrical conductors, and

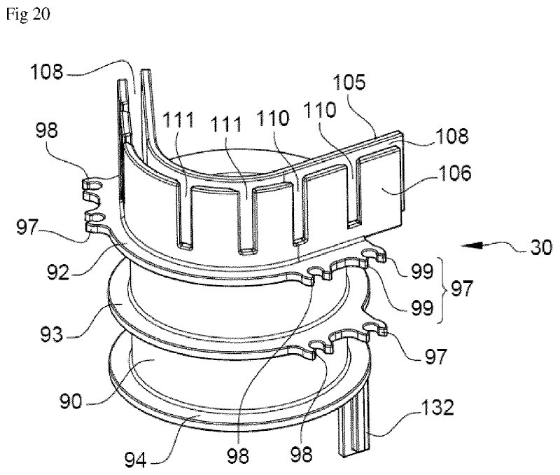

FIG. 20 shows the support of electrical conductors from FIG. 19 without its electrical conductors.

FIG. 1 shows a part of the electrical circuit 1 of a component for supplying electric power to a vehicle electrical energy storage unit. This component is also referred to as a “charger”. The electrical energy storage unit, not shown in this FIG. 1, is, for example, a battery, which can have a nominal voltage greater than 60 V, for example greater than or equal to 300 V, 400 V, 800 V, or even 1000 V.

The circuit 10 receives at its input an AC voltage from a network which is not shown and which is three-phase here. A rectifier which converts this AC voltage into a DC voltage and, where applicable, also performs a power factor correction function, is arranged upstream of a DC bus 11. An isolated voltage converter 12, in this case a DC/DC converter, is arranged downstream of this DC bus, from the electrical network. This converter 12 comprises, in a known manner, an inverter 14, a three-phase transformer 15, and a rectifier 16 providing the vehicle with a DC voltage which is isolated from the electrical network. As can be seen in FIG. 1, the three-phase transformer 15 is connected to both the rectifier 16 and the inverter 14 by a block of inductors 17 and a block of capacitors 18, so as to define a CLLLC structure. Other structures are, of course, possible, such as an LLC, CLLC, LC or else CL structure.

As can be seen in FIG. 1, each phase has a primary winding 20 and a secondary winding 21 inductively coupled to one another, and the primary windings 20 are star-connected and the secondary windings 21 are also star-connected.

In the example considered, the three-phase transformer 15 comprises a magnetic circuit 22 comprising a first part 23 and a second part 24. Each part 23, 24 comprises: a base 26 having a substantially triangular outline, and three studs 27 each extending in the direction of the base 26 of the other part of the magnetic circuit 22. Each base 26 has an outline defining an equilateral triangle here.

The transformer 15 further comprises three supports 30 of the electrical conductors 31, 32, each support 30 here being mounted on two facing studs 27 belonging to one and the other of the parts 23, 24 of the magnetic circuit, respectively. Two electrical conductors 31, 32 linked to one and the same support 30 have a portion defining a primary winding 20 and a portion defining a secondary winding 21, respectively. These electrical conductors 31, 32 are, for example, Litz wire.

As can be seen in FIG. 2, the three supports 30 of the electrical conductors 31, 32 are positioned so as to define an equilateral triangle.

The transformer 15 further comprises a casing 50 comprising a body 51 closed by a cover 52, which are visible in FIGS. 4 and 6. This body 51 and this cover 52 are, for example, made of metal, for example of aluminum. The supports 30 and the magnetic circuit 22 are arranged inside the casing 50. The body 51 is filled with a resin able to be polymerized to harden and immobilize the components arranged inside the casing (referred to as “potting”).

As can be seen in FIGS. 4 and 6, the casing 50 also has a triangular outline, being more precisely an equilateral triangle here. The casing is, in the example considered, exclusively formed by the body 51 and the cover 52 but the invention is not limited to a casing 50 made up of two parts.

As can be seen in FIG. 3, each stud 27 defines its own air gap 28, for example via an area of the stud 27 filled with non-magnetic material such as a glass-fiber-reinforced epoxy resin composite (FR4) or ceramic. This area occupied by this non-magnetic material defines, for example, a whole slice of the stud. A plurality of sections are, for example, assembled with this area of the stud 27 to form this stud 27.

As can be seen in FIG. 3, an additional air gap 29 is present between the facing ends of two studs 27 belonging to different parts 23, 24 of the magnetic circuit 22, respectively. Thus, in the example of the magnetic circuit 22 considered, each magnetic field allowing inductive coupling between a primary winding 20 and a secondary winding 21 crosses exactly three air gaps.

Still in FIG. 3, it can be seen that the magnetic circuit 22 of the example considered comprises a central leg 40 carried by one of the parts 23, 24 of the magnetic circuit 22. This central leg 40 is made here in one piece with the part 23 of the magnetic circuit 22 which carries it.

It can be seen in FIG. 3 that the central leg 40 extends, in this example, continuously between two ends, each being in contact with one of the bases 26 of the magnetic circuit 22 so that no air gap is created in the central leg 40.

It can also be seen in FIG. 3 or in FIG. 16 that the central leg 40 has a core 41 and three protrusions 42 extending from this core 41, each protrusion 42 extending between two neighboring studs 27 carried by one and the same part of the magnetic circuit.

As can be seen in FIG. 3, in the example considered, each stud 27 has a circular exterior outline, and each protrusion 42 of the central leg 40 here has a rounded wall facing the studs 27.

As can be seen in FIG. 2, the three-phase transformer 15 comprises a connection terminal block 45. This terminal block 45 is attached to one side of the casing 50 of the three-phase transformer 15. As can be seen in FIG. 2, the terminal block 45 here defines six terminals 60 for connecting the three-phase transformer 15 to the rest of the electrical circuit 10, these terminals 60 being shown schematically in FIG. 1. These terminals 60 come into contact here with electrical tracks of an electronic board (not shown).

As shown in FIG. 2, the terminal block 45 shows an elongated shape, and the six terminals 60 are arranged here in a row.

The various elements of the terminal block 45 according to this exemplary embodiment will now be described with reference to FIGS. 7 to 9.

The terminal block 45 here comprises a body 61 and a plurality of electrically conductive bars 62, each terminal 60 being defined by a portion 63 of a bar. Each portion 63 is planar here so as to come into contact with an electrical track of the electronic board mentioned above. The body 61 can be made of plastic, for example of PBT, PA, etc.

Each electrically conductive bar 62 has, for example, a portion 65, opposite the portion 63 defining the terminal, which is electrically connected to one of the electrical conductors 31, 32, here via a hollow sleeve 66 inside which the conductor 31, 32 is inserted, for example attached by crimping or welding.

Each electrically conductive bar 62 locally comprises a hole 67 and this electrically conductive bar 62 is attached to the body 61 by means of a screw 68 received in this hole 67. The body 61 here comprises six housings 69, and each of these housings receives an insert 70 which houses a hole 71, the above-mentioned screw 68 being received in an insert hole 71. Thus, the electrically conductive bar 62 is attached to the body 61 via the screw 68 and the insert 70 received in the housing 69. Each insert 70 can be made of metal, in particular of steel. As a variant, each insert is made of composite material. Six inserts are provided, for example, and, in the example considered, all these inserts 70 have the same shape and the same dimensions. In addition to ensuring the attachment of an electrically conductive bar 62 to the body 61, each screw 68 can also ensure the attachment of the electrically conductive bar 62 to the electronic board (not shown).

As can be seen in FIG. 8, each insert 70 can define a positioning relief 73 for positioning the portion 63 of the electrically conductive bar defining the hole 67. This positioning relief 73 is, for example, a flat part of circular shape.

As can be seen in FIGS. 2, 7 and 8, the exterior wall of each housing 69 can house a recess 75 able to accommodate an end portion 64 of the electrically conductive bar 62 in order to ensure correct positioning of this bar on the body 61 and to prevent any relative rotation between this bar and this body.

In another exemplary embodiment (not shown), the body 61 comprises a plurality of housings 69 which receive the screws 68 directly, in the absence of an insert 70. In this other exemplary embodiment, the electrically conductive bar 62 is attached to the body 61 directly via the screw 68, without an intermediate piece.

As can be seen in FIGS. 4 and 5, each support 30 of electrical conductors can integrate a holding system 80 for holding the cover 52 on this support 30.

Each support 30 comprises, for example, a single pin 81 protruding in relation to the rest of the support 30 along the longitudinal axis of the latter. As a variant, only two of the three supports of the transformer 15 comprise a pin 81, the third support 30 being devoid of said pin.

FIG. 5 shows a pin 81 in detail, wherein the latter can have a section that is perpendicular to the longitudinal axis of the support which is cruciform. Each pin 81 of a support 30 of the electrical conductors is, in the example considered, received by force in an opening made in the cover 52, as can be seen in FIG. 4. The relative arrangement of the pins 81 of the supports 30 makes it possible to immobilize the cover 52.

As can be seen in FIG. 5, the holding system 80 for holding the cover 52 on the sup-port 30 can extend along the longitudinal axis of the support 30 on the same side of the sup-port 30 as a guidance system 85 for guiding electrical conductors, which will be described with reference to FIGS. 18 to 20.

In these FIGS. 18 to 20, the holding system 80 is not shown, it being possible for the guidance system 85 to be present without necessarily the holding system 80 being present.

As can be seen in FIG. 18, each electrical conductor 31, 32 supported by a support 30 of the transformer 15 can be guided outside the winding 20, 21 that it defines.

In the example considered, each of these conductors 31, 32 is guided by the guidance system 85 beyond each of the ends of the electrical winding 20, 21 that it defines. As already mentioned above, the first ends of the electrical conductors can form an output to the electrical circuit 10 outside the transformer 15, and three of the second ends of the electrical conductors can lead towards a common point via a star connection to the primary, and three others of these second ends of the electrical conductors can lead towards a common point via another star connection to the secondary.

The support 30 of the two electrical windings 31, 32 comprises:
a wall 90 around which the electrical windings 20, 21 are arranged, and this wall 90 defines, in the example considered but in a non-limiting manner, a hollow cylinder of circular cross section, and
three edges 92, 93, 94 offset along the longitudinal axis of the support so that one of the electrical windings 31 is arranged between the first 92 and the second 92 edge and that the other of the electrical windings 32 is arranged between the second 93 and the third 94 edge, as is clearly visible in FIG. 2 for example. The gap between two consecutive edges 92, 93 and 93, 94 remains constant in the example considered.

The guidance system 85 acts on the electrical conductors, on the one hand via clamps 97 and 98, and on the other hand via additional walls 105 and 106.

In the example shown in FIGS. 18 to 20, the guidance system 85 comprises, for each electrical conductor 31, 32, on the one hand a first clamp 97 interworking with this electrical conductor 31, 32 beyond the first end of the electrical winding 20, 21 that it defines. Such a clamp 97 has, for example, two arms 99 that are curved such that they follow an area of the outline of this end of the electrical conductor, as shown in FIG. 18 or 20. A circular outline is involved in this case. Each clamp 97 is, for example but in a non-limiting manner, made in one piece with the rest of the support 30 of electrical conductors. As already explained, each first clamp 97 interworks, for example, with a portion of electrical conductor 31, 32 on its way towards a connection terminal 60.

The guidance system 85 comprises, on the other hand, a second clamp 98 interworking with the electrical conductor beyond the second end of the electrical winding that it defines, these first 97 and second 98 clamps following one another along one of the first 92, second 93 and third 94 edges. As already explained, each second clamp 98 interworks, for example, with a portion of electrical conductor 31, 32 on the way towards a common point of a star connection.

More precisely, in the example considered:
the first edge 92 comprises two first clamps 97 which each respectively interwork with one of the electrical conductors 31, 32 beyond the first end of the electrical winding 20, 21 that it defines, and two second clamps 98 which each respectively interwork with an electrical conductor beyond the second end of this electrical winding 20, 21, and
the second edge 93 comprises a first clamp 97, arranged beneath a first clamp 97 of the first edge 92, and a second clamp 98, arranged beneath a second clamp 98 of the first edge. The clamps carried by the second edge 94 make it possible to guide the electrical conductor 32 outside the electrical winding arranged between the second edge 93 and the third edge 94.

It can be seen in FIGS. 18 to 20 that two pairs of clamps each formed of a first clamp 97 and of a second clamp 98 are found along the edge 92 and that the gap between two pairs of clamps is greater than the distance between two clamps of the same pair.

It can also be seen in these FIGS. 19 and 20 that the clamps 97, 98 carried by the second edge 93 are aligned along the axis of the cylindrical wall 90 with clamps 97, 98 carried by the first edge 92.

The two additional walls 105 and 106 of the guidance system 85 will now be described. These two additional walls 105 and 106 are offset here so as to define between them a guidance channel 108 receiving in a stacked manner the electrical conductors 31, 32 outside the windings 20, 21 that they define. The channel 108 has a constant dimension here. These additional walls extend, in the example considered, on both sides of an arc-shaped portion of the first edge 92, protruding axially beyond this first edge 92. In the area overlapping with this first edge 92, the additional walls 105 and 106 each define an arc-shaped portion, the wall 106 having a radius of greater than the wall 105, as is also visible in FIG. 17. FIGS. 17 and 18 show that the additional walls 105 and 106 are made here of a single piece with the first edge 92.

It can be seen in FIGS. 18 to 20 that the wall 106 comprises first openings 110 for the passage of the electrical conductors 31, 32 towards the electrical winding 20, 21 that it defines, and second openings 111 through which no electrical winding passes. It can be seen that the first openings 110 are arranged radially facing a clamp 97, 98.

In the example shown in FIGS. 10 to 12, each support 30 of the electrical conductors 31, 32 also integrates a holding system 120 for holding onto the body 51 of the casing 50. Here, this holding system 120 comprises a pin 121 having, in this example, a section which is perpendicular to the longitudinal axis of the support which is cruciform. This pin 121 extends axially away from the rest of the support 30 from the third edge 94. As can be seen in FIGS. 10 and 12, each pin 121 is received by force in an opening 122 made in the body 51 of the casing 50. This holding system can ensure that the magnetic circuit 22 is immobilized on the body 51 of the casing before the resin contained in this casing 50 polymerizes.

When such holding systems 120 exist, they may or may not be combined with the holding systems 80 and the guidance systems 85 mentioned above. As can be seen in FIGS. 10 to 12, each holding system 120 can thus extend axially from one side of the support 30 while the holding system 80 and the guidance system 85 extend axially from the opposite side of the support 30.

A functionality which can be integrated into all or some of the supports 30 of electrical conductors 31, 32 will now be described with reference to FIGS. 13 to 15. A holding system 130 for holding the support 30 of the electrical conductors 31, 32 on the magnetic circuit 22 is thus provided. This holding system 130 is in the form of two blocks 132 protruding in relation to the rest of the support 30. When the holding system 120 is provided, these systems 130 and 120 can extend axially from the same side of the support, the pin 121 and a block 132 being arranged, in particular, side-by-side as can be seen in the example shown in FIG. 11.

Each block 132 here defines a surface 135 coming into contact with a surface 136 of a base 26 of the magnetic circuit 22. The surfaces 135 and 136 are planar here. Each block 132 is, for example, supported by a reinforcement 133, as can be seen in FIG. 11.

As can be inferred from FIG. 15, the interworking between the two blocks 132 of a support 30 and the base 26 can ensure rotational immobilization of the support 30 on the magnetic circuit 22.

Another functionality which can be integrated into all or some of the supports 30 of the electrical conductors 31, 32 will now be described with reference to FIGS. 13 to 16. It can be seen in these figures that the cylindrical wall 90 of the support 30 comprises ribs 142 extending away from the wall 90 in the direction of the stud 27 on which this support is mounted.

In the example considered, six ribs 142 are provided but the invention is not limited to a precise number of ribs 142. These six ribs 142 thus make up a spacing system 140 for spacing the cylindrical wall 90, and therefore the electrical windings 20, 21 that it carries, from the stud 27.

It can be seen in the FIGS. 13 to 16 that all the ribs 142 can have the same shape and can be distributed uniformly around the stud 27.

It can also be seen in these figures that each rib 142 can extend continuously along the axis of the support 30 from the first edge 92 up to the third edge 94.

In a variant which is not shown, all or some of the ribs extend discontinuously along the axis of the support 30.

As can be seen in FIG. 16, each rib 142 does not extend, for example, up to the stud 27 on which the support 30 is mounted. An empty space ensuring easy assembly thus remains present between each end of a rib facing the stud 27 and this stud 27.

As already mentioned, each support 30 of the electrical conductors 31, 32 can be made in one piece.

When this support 30 integrates:
the ribs 142, and/or
the holding system 80 for holding the cover 52 on the support, and/or
the guidance system 85 for guiding electrical conductors, and/or
the holding system 120 for holding the support on the body 51 of the casing, and/or
the holding system 130 for holding the support on the magnetic circuit 22, all these systems may or may not be made in one piece with the rest of the support 30. In one particular example, the support 30 is thus in one piece and has all or some of the above-mentioned functionalities.

The invention is not limited to the examples that have been described above.

1. An electronic component, comprising:
a magnetic circuit,
two electrical conductors each having a portion arranged around a same part of the magnetic circuit, each of said portions forming a winding between a first and a second end, these two windings being inductively coupled to one another via the magnetic circuit, and
a support of the two electrical windings, arranged between said electrical conductors and said part of the magnetic circuit,
the support integrating a guidance system of at least one of the two electrical conductors outside the electrical winding that it defines,
the support of the two electrical windings comprising a wall around which the electrical windings are arranged, this wall being, in particular, cylindrical and having a circular cross section, and three edges offset along the longitudinal axis of the support, such that one of the electrical windings is arranged between the first and the second edge and the other of the electrical windings is arranged between the second and the third edge,
wherein the guidance system comprises two additional walls extending along the longitudinal axis of the support beyond the first edge, these two additional walls being offset and defining between them a guidance channel receiving at least one of the electrical conductors outside the electrical winding that it defines.

2. The component as claimed in claim 1, the guidance system guiding at least one of the two electrical conductors outside the electrical winding that it defines beyond the first end of the electrical winding and beyond the second end of the electrical winding.

3. The component as claimed in claim 1, the guidance system comprising a first clamp interworking with one of the electrical conductors beyond the first end of the electrical winding defined by it.

4. The component as claimed in claim 3, the guidance system comprising a second clamp interworking with the electrical conductor beyond the second end of the electrical winding that it defines, these first and second clamps following one another along one of the first, second and third edges.

5. The component as claimed in claim 4, the guidance system comprising:
a first clamp interworking with one of the electrical conductors beyond the first end of the electrical winding that it defines, and a second clamp interworking with the electrical conductor beyond the second end of this electrical winding, these first and second clamps following one another along one of the first, second and third edges, and
a first clamp interworking with the other of the electrical conductors beyond the first end of the electrical winding that it defines and a second clamp interworking with this other electrical conductor beyond the second end of this electrical winding, these first and second clamps following one another along said edge amongst the first, second and third edges.

6. The component as claimed in claim 5, the two first clamps being separated by a distance greater than the shortest distance between a first clamp and a second clamp.

7. The component as claimed in claim 5, the first edge carrying two first clamps and two second clamps, interworking respectively with an electrical conductor, and the second edge carrying a first clamp and a second clamp interworking with one of the electrical conductors, each clamp of the second edge being, in particular, aligned with a clamp of the first edge along the longitudinal axis of the support.

8. The component as claimed in claim 1, the wall around which the electrical windings are arranged being cylindrical and having a circular cross section, and each additional wall having a cylindrical shape, in its portion extending beyond the cylindrical wall along the axis of that cylindrical wall.

9. The component as claimed in claim 1, one of the additional walls comprising openings for the passage of an electrical conductor to the electrical winding that it defines.

10. The component as claimed in claim 1, the support and the guidance system being made in one piece.

11. The component as claimed in claim 1, defining a transformer for an isolated voltage converter.

12. The component as claimed in claim 11, defining a three-phase transformer for an isolated voltage converter, comprising three supports of electrical conductors, each support being arranged around a part of the magnetic circuit and supporting two windings inductively coupled to one another via the magnetic circuit, the supports defining, in particular, a geometric pattern of an equilateral triangle.

13. A component for supplying electric power to a vehicle electrical energy storage unit, comprising the component as claimed in claim 11.

14. The component as claimed in claim 2, the guidance system comprising a first clamp interworking with one of the electrical conductors beyond the first end of the electrical winding defined by it.

15. The component as claimed in claim 6, the first edge carrying two first clamps and two second clamps, interworking respectively with an electrical conductor, and the second edge carrying a first clamp and a second clamp interworking with one of the electrical conductors, each clamp of the second edge being, in particular, aligned with a clamp of the first edge along the longitudinal axis of the support.

16. The component as claimed in claim 2, the wall around which the electrical windings are arranged being cylindrical and having a circular cross section, and each additional wall having a cylindrical shape, in its portion extending beyond the cylindrical wall along the axis of that cylindrical wall.

17. The component as claimed in claim 2, one of the additional walls comprising openings for the passage of an electrical conductor to the electrical winding that it defines.

18. The component as claimed in claim 2, the support and the guidance system being made in one piece.

19. The component as claimed in claim 2, defining a transformer for an isolated voltage converter.

20. A component for supplying electric power to a vehicle electrical energy storage unit, comprising the component as claimed in claim 12.
